(19) United States
(12) Patent Application Publication
(10) Pub. No.: US 2013/0013507 A1
(43) Pub. Date: Jan. 10, 2013

(54) System to Create and Manage Payment Accounts

(76) Inventors: Christopher S. Browning, Gulf Breeze, FL (US); Kara Lynn Szostek, Pensacola, FL (US); Daniel Lee Reib, Gulf Breeze, FL (US); Thomas R. Lunsford, JR., Pensacola, FL (US); Jeffrey Peter Dykstra, Pensacola, FL (US)

(21) Appl. No.: 13/439,711

(22) Filed: Apr. 4, 2012

Related U.S. Application Data
(60) Provisional application No. 61/471,554, filed on Apr. 4, 2011.

(51) Int. Cl. G06Q 20/04; G06Q 40/00

(52) U.S. Cl. 705/44; 705/39

(57) ABSTRACT

A hosted-software system including separate but integrated application modules configured to manage notification, validation, authorization, receipt, disbursement, and reporting of payment and transaction types processes and apply specialized and customizable business rules, access rights, and permissions configured to allow secure and definable transaction processing and other interactions between multiple related and disparate parties.

### CROSS-REFERENCE TO RELATED APPLICATION

This Patent Application claims priority to U.S. Provisional Patent Application Ser. No. 61/471,554 filed Apr. 4, 2011, the entire contents of which is herein incorporated by reference in its entirety.

### BACKGROUND

1. Field

Method, System, and Apparatus The present inventive concept relates to a system configured to create and manage accounts and perform efficient and secure payment transactions using the accounts.

2. Discussion of Related Art

Payment systems have existed for many years. Typically, such systems comprise closed or semi-closed systems utilized by a limited number of different stakeholders to exchange transaction information and conduct business. As a result of the expanding reach of the Internet, various stakeholders benefited from the proliferation of increasingly diverse and tailored payment applications. Examples of existing payment systems include online banking software, e.g., software sold under the trademark NETTELLER, credit card payment systems exemplified by hardware terminals, e.g., terminals sold under the trademark VERIFONE, distributed software used and installed by merchant, e.g., software sold under the trademark ICVERIFY, or online payment services, e.g., software sold under the trademark AUTHORIZE.NET.

Such conventional systems suffer from a number of limitations. Many conventional systems provide inadequate security to store sensitive information. Further, many conventional systems have inadequate authentication protocols to ensure that misuse of the conventional system does not occur. In addition, many conventional systems are unable to accommodate a large numbers of users without sacrificing performance and/or failing to provide suitable granular control and permissions reflective of the varied roles users may have.

As technology advances, there is an increasing demand for organizations to simultaneously work with multiple parties in trade relationships, and an increasing array of users that require access to and monitoring of financial transaction processing. Convention systems, however, do not allow for dynamic and secure creation and management of users and permissions in a payment system that is inter-networked and multi-dimensional.

### SUMMARY

The following brief description is provided to indicate the nature of the subject matter disclosed herein. While certain aspects of the present inventive concept are described below, the summary is not intended to limit the scope of the present inventive concept. Embodiments of the present inventive concept provide a single and/or multi-party payment processing system configured for operating in an online environment, e.g., the Internet, with single and/or multiple users representing single and/or multi-party entities, with corresponding dynamically assigned permissions and/or access methods.

The aforementioned may be achieved in one aspect of the present invention by providing a system to process a payment transaction. The system may include a navigator module for controlling access to a plurality of payment-related applications. The navigator module may include a plurality of permission-aware application tools. The plurality of payment-related applications may include a data tokenization application, online payment processing application, web-service style online interface application, and/or a file based interface application.

The system may further include a security application for defining access controls, user restrictions, and/or transaction processing thresholds of the system. The permission-aware application tools may be made available according to permissions associated with a user. The payment-related applications may be fully interoperable. Access to and/or use of each of the payment-related applications may be controlled by the navigator module using granular permissions.

The system may further include a web-based server for storing and/or running the system. The system may further include an enterprise server for storing and running the system. The system may further include an instant help application for providing access to information according to the user's permissions. The system may further include a transaction processing engine for processing the payment transaction. The transaction processing engine may be configured to identify and use an associated processor to void the payment transaction without intervention of the user. The payment transaction may be a rejected payment transaction. The transaction processing engine may be configured to recognize the rejected payment transaction, identify, and/or communicate with a processor to request verbal authorization, and/or process the rejected payment transaction upon verbal authorization.

The aforementioned may be achieved in another aspect of the present invention by providing a method to classify business flows to determine what flows should continue and what flows should be handled as exceptions due to a business rule violation. The method may include one or more steps such as receiving one or more business rule triggers, receiving one or more business objects, exchanging information with at least one of a core business rules engine, an assigned rules engine, and a decision tree evaluation engine, performing a first checking step of predefined business rules in a core business rules engine, performing a second checking step of business rules in an assigned rules engine, performing a decision process by combining results from the first checking step and the second checking step and/or outputting a business rule result.

The aforementioned may be achieved in another aspect of the present invention by providing a method to create, assign, and/or manage permissions and/or claims. The method include one or more steps such as controlling access at least one payment-related application via a navigator module including at least one permission-aware application tool, and/or defining access controls, user restrictions, and transaction processing thresholds of the system via a security application. The at least one permission-aware tool may be made available according to at least one permission associated with at least one user. Access to the at least one payment-related application may be controlled by the navigator module using granular permissions. The at least one permission-aware application tool may include (i) a data tokenization application, (ii) online payment processing application, (iii) web-service style online interface application, and/or (iv) a file based interface application. The at least one payment-related application may include a plurality of payment-related application that are fully interoperable with each other.

The method may further include the steps of storing and/or running the system via a web-based server or an enterprise server. The method may further include the step of providing access to information according to the permissions associated with the user via an instant help application. The method may further include the step of processing the payment transaction via a transaction processing engine. The method may further include the step of automatically identifying and/or using an associated processor to void the payment transaction via the transaction processing engine. The method may further include the step of using the transaction processing engine to (i) recognize the payment transaction, (ii) identify and communicate with a processor to request verbal authorization, and/or (iii) process the payment transaction upon verbal authorization.

Additional aspects, advantages, and utilities of the present invention will be set forth in part in the description which follows and, in part, will be obvious from the description, or may be learned by practice of the present invention.

### BRIEF DESCRIPTION OF THE DRAWINGS

The present inventive concept is described in detail below with reference to the attached drawing figures, wherein:

FIG. 1 is a flowchart illustrating a system of the present inventive concept;

FIG. 2 is a simplified flowchart illustrating interaction between client business objects and core system business objects of the present inventive concept;

FIG. 3 is a flowchart illustrating a system of the present inventive concept;

FIG. 4 is a flowchart illustrating a system of the present inventive concept;

FIG. 5 is a flowchart illustrating a business rules engine of the present inventive concept;

FIG. 6 is a flowchart illustrating elements of a system of the present inventive concept; and

FIG. 7 is a flowchart illustrating elements of a system of the present inventive concept.

The drawing figures do not limit the present inventive concept to the specific examples disclosed and described herein. The drawings are not necessarily to scale, emphasis instead being placed upon clearly illustrating the principles of the present inventive concept.

### DETAILED DESCRIPTION

The following detailed description references the accompanying drawings that illustrate the present inventive concept. The illustrations and description are intended to describe aspects of the present inventive concept in sufficient detail to enable those skilled in the art to practice the present inventive concept. Other components can be utilized and changes can be made without departing from the scope of the present inventive concept. The following detailed description is, therefore, not to be taken in a limiting sense. The scope of the present inventive concept is defined only by the appended claims, along with the full scope of equivalents to which such claims are entitled.

In this description, references to “one embodiment,” “an embodiment,” or “embodiments” mean that the feature or features being referred to are included in at least one embodiment of the present inventive concept. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present inventive concept can include a variety of combinations and/or integrations of the embodiments described herein.

In this description, applications or system components may be referred to for purposes of convenience with trademarks or service marks of certain businesses. Such trademarks and service marks are not used in a generic sense, but rather to refer to components produced and/or distributed by particular business entities, and which have the functionality described in greater detail herein. Reference to particular components produced by particular entities results from ease of familiarity of the applicant, and is not intended to limit the present inventive concept to components having a particular source, but rather the scope of the claims should be read to encompass components embodying the functionalities and characteristics described herein.

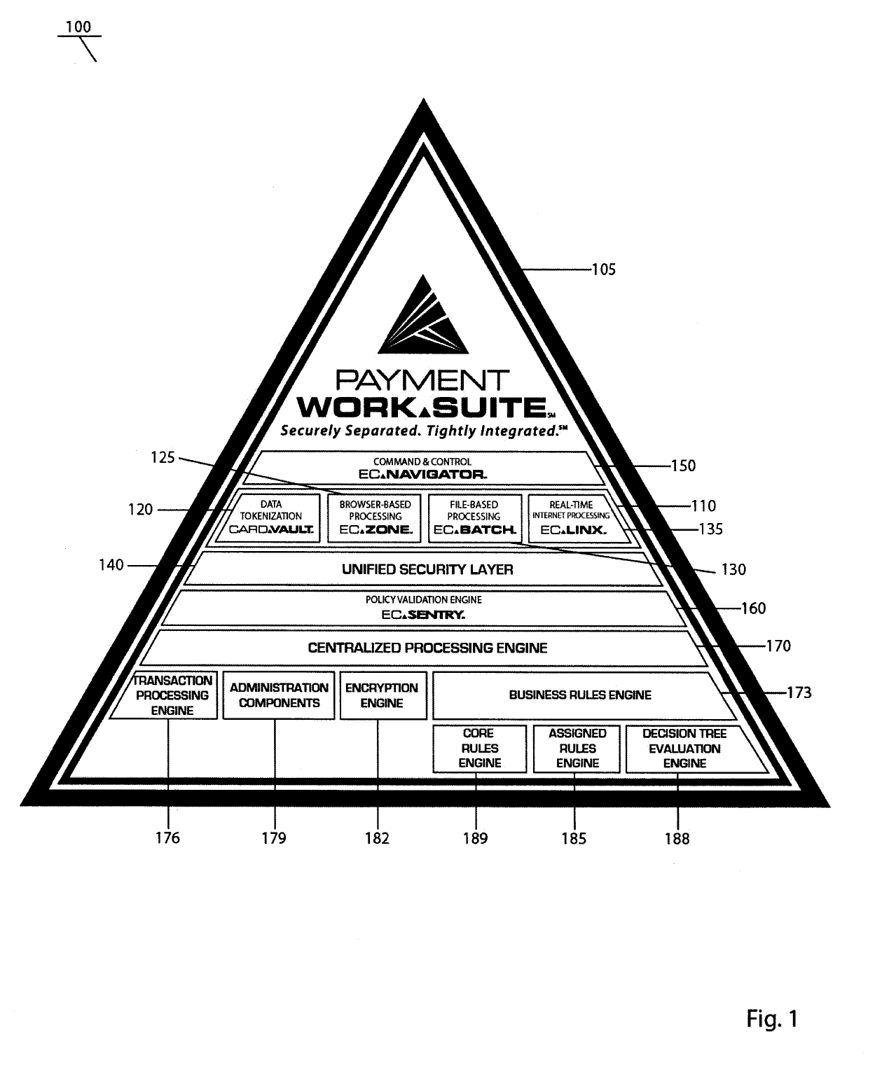

FIG. 1 illustrates a payment system 100 according to an exemplary embodiment of the present inventive concept. The payment system 100 generally includes a high-performance payment platform 105 that may be software, at least provide functionality of software, sold under the trademark PAYMENT WORKSUITE or the like. The payment platform 105 includes one or more different payment-related applications 110. System 100 is configured to perform one or more techniques at various levels of abstraction to provide security, account, and/or process integrity for simple and/or complex payment and/or transaction processing for a variety of customers, e.g., payors, and/or their counterparties, e.g., payees, whether businesses, public institutions, or consumers. The system 100 is configured to deliver increased productivity to such customers while helping to reduce costs and business risk through the provisioning of comprehensive security, extensible design, and/or administrative controls. Further, the system 100 provides centralized and robust fraud detection and prevention.

In the exemplary embodiment, one or more payment-related applications 110 are fully interoperable with one another. Access and use of each of the payment-related applications 110 is tightly controlled through granular, assignable rights, permissions and/or security measures that provide clients with increased confidence during complex transactions with unconfirmed data.

In the exemplary embodiment, a navigator module 150 is provided, which may be a browser-based module that is configured to integrate with and control the one or more payment-related applications 110. The navigator module 150 may include software sold under the trademark EC-NAVIGATOR or the like. Permission-based access is implemented with the navigator module 150 and the payment-related applications 110, to increase account integrity and minimize risk by automatically displaying and allowing access to individual users only a minimal amount of information, e.g., pertinent information necessary to process and/or authorize a transaction. Such information may be controlled permission-aware software.

Comprehensive administrative tools, made available to the user via the navigator module 150, provide a user of the system 100 with enhanced usage-rights definition control to further secure user access as well as facilitate management of merchant information, customer accounts, and/or cardholder information. It is foreseen, however, that the administrative controls may control any form of sensitive data, i.e., any data the user desires to secure or conceal from others. The navigator module 150 is configured to provide advanced reporting, which facilitates daily operations and decision-making of the user. For instance, the navigator module 150 may be configured to provide multi-level information about one or more transactions, the user and/or another user's activity, and/or stored data across one or all of the applications of the system 100. In the exemplary embodiment, the navigator module 150 is fully integrated into and configured to operate and control each of the payment-related applications 110. It is foreseen, however, that the navigator module 150 may be configured to operate and control only a limited number of the payment-related applications 110.

In the exemplary embodiment, the payment-related applications 110 include one or more software applications such as, but not limited to, data-tokenization software 120, browser-based software 125, real-time processing software 135, and/or file-based processing software 130.

The data-tokenization software 120 is configured to provide data tokenization, for example, to replace or substitute sensitive data of the user with one or more proxy values that are only meaningful in the contextual relationship between the user and an operator of the system 100. In this manner, the system 100 conceals the sensitive data. The data-tokenization software 120 may be software sold under the trademark CARDVAULT or the like.

The browser-based software 125 provides browser-based online payment processing system, e.g., a payment processing system on the Internet. The browser-based software 125 may be software sold under the trademark EC-ZONE or the like. The real-time processing software 135 is configured to provide a web-service style online interface for system-to-system communication and processing between the user and one or more clients. The real-time processing software 135 may be software sold under the trademark EC-LINX or the like. The file-based processing software 130 is configured to provide a file-based interface to process payments. The file-based processing software 130 may be software sold under the trademark EC-BATCH or the like. In this manner, the system 100 is respectively configured to (i) process payments on the Internet using a web browser, (ii) enable communication between a plurality of systems, and/or (iii) provide a file-based interface for processing payments.

The system 100 is further configured to provide data tokenization and/or storage services via the data-tokenization software 120 to enhance security of data or sensitive information, e.g., card information stored in a memory of the system 100. The sensitive information may include, but is not limited to, cardholder data such as a primary account number or PAN. In this manner, the system 100 is configured to safely and securely process card payment transactions. The system 100 may be configured to store the sensitive information remotely, for instance, at one or more Payment Card Industry Data Security Standard (PCI DSS) compliant data centers. In this manner, the system 100 improves and otherwise ensures PCI compliance for a merchant using the system 100. The data-tokenization software 120 may provide additional storage record capability for other sensitive data of the user. For instance, the system 100 may securely store and protect from inadvertent disclosure HIPAA and/or other Privacy Act information supporting, for instance, business continuity plans by maintaining a secure copy of tokenized data off-site or otherwise in a remote location relative to the user.

The browser-based software 125 is configured to provide an online Virtual Payment Application configured to process data of a purchase card, credit card, and/or other electronic payment transactions with minimal investment and development. In another embodiment of the system 100, a virtual point of sale (VPOS) is provided by the browser-based software 125 for processing transactions. In this manner, the browser-based software 125 provides the user and/or merchant with an easy-to-use and affordable system.

The file-based processing software 130 is configured to permit companies to send credit card authorizations and/or settlement transactions via batch files. The file-based processing software 130 is configured to permit multiple transactions to be bundled together with each other, if there is one or a plurality of transactions, encrypted in a file, and processed using secure File Transfer Protocol (FTP) with file-level encryption, e.g., SFTP or FTPS. Using the file-based processing software 130, the system 100 is configured to deliver a transaction confirmation to one or more systems so that the user and or one or more others may confirm that the transaction was processed correctly. The file-based processing software 130 may be utilized by one or more merchants without requiring real-time authorization. The file-based processing software 130 may be used to invoice, in high and/or low volume, order entry situations, recurring payments, and/or to process one or more payment transactions. In another embodiment, the file-based processing software 130 allows resellers to create and/or manage one or more merchants, provide reporting information, and/or provide other and/or a variety of file based formats to accommodate various demands of the user and/or merchant.

The real-time processing software 135 is configured to provide real-time payment processing and/or authorization to the user and/or the merchant using or developing one or more applications and host-to-host, real-time payment transactions via the Internet. In the exemplary embodiment, the real-time processing software 135 is integrated directly with a Web commerce system, enterprise resource system, and/or other computer system of the user and/or the merchant. In another embodiment, the real-time processing software 135 is configured to permit one or more resellers to create and/or manage one or more merchants, provide reporting information, and/or provide other general web service interfaces thereby providing additional functionality to the system 100.

The system 100 further includes policy validation software 160 configured to permit the user to define one or more access controls, one or more user restrictions, and/or one or more transaction processing thresholds to help identify and/or intercept any suspicious or unusual data indicative of behavior by another user of the system 100 irrespective of where the unusual data originated. The user of the system 100 is provided with granular control via the system 100. In this manner, the user of the system 100 may apply one or more restrictions universally to all other users of the system 100 or to one or more other individual users of the system 100. Such restrictions may be based on, for example, management level or job function of the one or more other users within an organization of the user, e.g., a business network. The policy validation software 160 is configured to be fully integrated into one or more applications within the high-performance payment system 105, for example, one or more of the software 120, 125, 130, 135, to help ensure system and process integrity of the system 100. It is foreseen that the policy validation software 160 may be software sold under the trademark EC-SENTRY or the like.

The policy validation software 160 is configured to provide fraud-fighting transaction verification and authentication tools, along with incorporating checks, restrictions and/or tolerances to help avoid costs associated with high-risk transactions. The enforcement of one or more specific business rules, or one or more policy constraints by the policy validation software 160, enables the system 100 to provide a highly effective fraud prevention tool. In the exemplary embodiment, one or more rules are customized based on processing activity expected by the user. For example, one or more individual rules and/or one or more time periods are customized to minutes, hours and/or days, and set according to one or more preferences of the user through checks including, but not limited to, exemplary process checks or verifications, access restrictions, and/or transaction tolerances. The processing checks may be transaction IP activity checks or standards enforcement to control one or more processes, and may include velocity checks, activity checks, credit activity checks, and/or address verification service (AVS) checks.

The velocity checks are configured to allow the system 100 to limit the number of times a specific purchase or credit card can be used within a given time period. The activity checks are configured to allow the system 100 to limit the number of transactions that can be processed within a given time period. The credit activity checks are configured to allow the system 100 to limit the number of credits, e.g., refunds, that can be processed within a given time period. The AVS checks are configured to allow the system 100 to automatically decline transactions when address verification fails. The transaction IP activity checks are configured to allow the system 100 to limit the number of transactions that can be processed from a specific Internet Protocol (IP) address within a given time period.

The access restrictions may include approved IP address lists so that the system 100 may be configured to permit the user to specify one or more IP addresses that may access one or more accounts of the user with any other IP address being blocked or prevented from accessing the one or more accounts of the user. This is an ideal security tool provided by the system 100 if the user or the merchant only processes transactions from predefined locations. The blocked IP address lists allow the user to specify a set of IP addresses that are explicitly denied access to the one or more accounts of the user while any other IP address is allowed to access the one or more accounts of the user. In this manner, the system 100 is configured to allow the user to proactively block IP addresses known by the user to be fraudulent. It is foreseen that the system 100 may communicate with and/or otherwise utilize a global blocked list for the user and/or other users of the system 100 to facilitate identification of and/or automatically block problematic IP addresses. Additionally, the system 100 may be configured to allow the user to set operating hours to prevent transactions from occurring outside the set operating hours. It is foreseen that the operating hours may be the regular or normal business hours of the user.

The transaction tolerances may include maximum transaction amounts, minimum transaction amounts, and/or maximum total credit amounts. The maximum transaction amounts allow the system 100 to ensure that individual transactions do not exceed a specified amount, e.g., a dollar amount specified by the user. The minimum transaction amounts allow the system 100 to ensure that one or more individual transactions are not less than a specified amount, e.g., a dollar amount specified by the user, such as the amount that is normal for a business, which protects against fraudulent validation checks of a credit card. The maximum total credit amounts allow the system 100 to ensure that the total amount of credits, e.g., refunds, processed during a given time period does not exceed a limit, e.g., a dollar amount specified by the user.

Using the policy validation software 160, the system 100 provides significantly reduced risk by detecting and blocking fraudulent activity. Advanced settings may enable enforcement by the system 100 of different transaction limits at different levels within an organization or other network of the user.

The policy validation software 160 is configured to provide one or more predetermined and customizable rules, a credit card or data card stored, e.g., by the system 100, and/or integration and/or reporting. Using the one or more rules, the system 100 is configured to (i) enable definition of one or more rules to prevent suspicious transactions from processing, (ii) enable different access and transaction limits associated with each level of an organization or network of the user, and/or (iii) provide enforcement of standard operating procedures of an organization or network of the user.

Using the credit card or data card securely stored, e.g., by the system 100, the system 100 is configured to (i) provide encryption of one or more purchases and/or credit cards via one or more unique keys, (ii) use of encryption, e.g., Secure Socket Layer (SSL) encryption, for a secure internet connection, and (iii) one or more usernames having unique login credentials with assigned permissions that are predetermined by the user to specifically define level of access of another user accessing the system 100 via a username.

Using the integration and reporting, the software 120, 125, 130, 135, and/or 160, is configured to communicate and/or otherwise cooperate with each other in the system 100, with such being administered in the navigator module 150. Additionally, using the integration and reporting, the system provides a set of browser-based advanced reporting tools common to varied services and services are integrated with enterprise accounting and back-office solutions, which may include, but are not limited to software sold under the trademarks SAP, JD EDWARDS, and ORACLE.

The system 100 provides layered security configured to be implemented by the system 100 via permissions enforced by the navigator module 150. In this manner, the system 100 can improve security including, for example, account integrity. As another example, during a user login process, user credentials can be automatically and transparently passed through multiple authentication tests to ensure valid entry into any of the applications of the system 100. In addition, stringent password criteria and password turnover can be enforced in the system 100 to provide additional security for accounts. In the exemplary embodiment, authentication tests performed by the system 100 include (i) information the user knows and enters, e.g., a client identification code, username, and/or passphrase, (ii) information the user recognizes, (iii) computer network IP address from which the user attempts to gain access to the system 100, (iv) challenge and response questions predetermined by the user, and/or (v) out-of-band communication methods to exchange PIN or other information. In the exemplary embodiment, preferred password criteria include (i) the password must contain eight characters, one number, one symbol, and one upper case character, (ii) the past five passwords cannot be reused, (iii) a user attempting to gain access to the system 100 is limited to five incorrect logon attempts before access by the user attempting to gain access is temporary blocked the system 100 for a predetermined amount of time, e.g., thirty minutes.

In the exemplary embodiment of the system 100, the user may specify password criteria such as, but not limited to out of band authentication, two factor authentication, and/or user defined image and/or text phrase to identify the authenticity of the website and guard against phishing.

In the exemplary embodiment of the system 100, after access is granted by the user to another user of the payment platform 105, an interface to the applications 110 can be tailored to each user's assigned permissions, e.g., individual users may be assigned a specific privilege or level of access based on a degree of access to the system 100 and/or functions of the system 100 as described herein. The assigned permissions of each individual user may be different from one another with some users having greater privileges or access to data of the system 100 and/or functions of the system 100 and other users having lesser privileges or access to data of the system 100 and/or functions of the system 100. In this manner, the system 100 secures more-valuable data separate from less-valuable data, thereby providing selective access to the system 100 based on the user. For example, an executive-level user may have permission to view all data and perform all tasks, while operating personnel may only see a few relevant sections.

The system 100 is configured to provide one or more account administrators with full control over one or more other users within a network. The control may include defining or otherwise setting permissions as well as administering changes to those permissions, which can be applied rapidly and instantly to the system 100. For ease of maintenance, user groups may be created for assignment of the same set of permissions to multiple users. In an embodiment, permissions may be assigned at the individual user level by the user.

Information about merchants, customers, and/or cardholder information can be easily added and updated via the navigator module 150 of the system 100. Expandable sections of permission-aware application tools may be made available to the user based on the functions or data relevant to the user's tasks and assigned capabilities, and allow a user of the payment platform 105 to focus on what is most important through display or restriction of groups of information. Generally, expandable sections can be areas in the navigator module 150 that can be maximized or minimized by the user, thereby allowing the user to hide and show different amounts of information on a given page.

On-page information lookup can significantly reduce search time. For example, the user may simply start typing and select the desired result as it appears using the system 100. In an embodiment, permission-aware instant help is conveniently accessible from each section of the system 100 to facilitate identification of answers to questions without requiring the user to leave a current page. In an embodiment, the system 100 may be configured to hide or otherwise conceal the instant help when not needed by the user.

The payment platform 105 is configured to consolidate and virtually organize data of the user in a hierarchy format, for example, based on how the data would be organized in a non-virtual environment, e.g., a real-world paper environment. In this manner, the user can effortlessly manage multiple merchants under a parent organization, multiple locations under a given merchant, and/or multiple terminals per location.

The navigator module 150 is configured to provide multiple views, interact with, manipulate and report payment data. Advanced filtering and column-sorting drive the online views for conducting quick evaluations, and detailed reports may be exported into multiple file formats for thorough offline analysis. Multiple merchants, locations and terminals may be selected for inclusive reports or excluded for specific inquiries. This comprehensive reporting system provides immediate access to operational information and empowers users to make decisions based on real-time intelligence.

Using the navigator module 150, the system 100 is configured to provide the user with secure access to pertinent information to a payment transaction and/or integration and reporting of the payment transaction. The access to pertinent information may include (i) one or more dynamic interfaces displayed based on one or more permissions, (ii) one or more dashboard views, messaging, and/or alerts, and/or (iii) context sensitive or help sections that may contain video and other multi-media content, and may be accessed via an RSS feed or the like. The secure access may be provided via (i) multi-layered security checks, (ii) use of encryption such as, but not limited to Secure Socket Layer (SSL) encryption for secure internet connections, and/or (iii) usernames with unique login credentials and assigned permissions configured to allow the user to specifically define level of access. Regarding integration and reporting, the system 100 with the data-tokenization software 120, the browser-based software 125, the real-time processing software 135, the file-based processing software 130, and/or the policy validation software 160, can be used in conjunction with each other and administered via the navigator module 150. Additionally, using the integration and reporting functionality, the system 100 equips any one or more of the applications 110 with the same set of browser-based advanced reporting tools.

Additional components within the payment platform 105 can include a centralized processing engine 170, a business rules engine 173, a transaction processing engine 176, a centralized software components to handle administration or administration components 179, an encryption engine 182, an assigned rules engine 185, and/or a decision tree evaluation engine 188.

In the exemplary embodiment, the transaction processing engine 176 is configured to provide varying types of credit card and other similar transactions, e.g., ACH transactions or the like. The transaction processing engine 176 is configured to automatically handle authorization only transactions, authorization and capture transactions, credits or refunds, e.g., stand alone or previous, and/or voids. The transaction processing engine 176 is configured to, for example, if a transaction is voided and the transaction processing engine 176 knows that the processor can immediately handle the voided transaction, automatically contact the processor and reverse the transaction. In such a circumstance, no user intervention is required by the system 100.

In another embodiment, the transaction processing engine 176 is configured to handle a gift card, for example, where a balance exists on the card and an updated balance remaining should be calculated after a transaction is complete. Also, if a particular payment mechanism, e.g., such as a credit card, is declined, the transaction processing engine 176 may be configured to contact the processor and, if the processor gives authorization, transaction processing engine 176 may proceed with a verbal authorization code (a.k.a., a “force” transaction). Further, in another embodiment, the processing engine 176 may process reversals, e.g., a void reversal, where a voided transaction occurs and a total amount or a partial amount is returned to a card. For example, in an application where a card is authorized for a $50 transactions, but the actual transaction is only for $45, the transaction processing engine 176 is configured to automatically put the $5 difference back on the card.

User permissions/claims can be checked by the business rules engine 173 and conveyed to the transaction processing engine 176. This could, for example, be used to detect and combat a rogue user, e.g., a user who tries to fraudulently add money to a card. Also, centralizing permission/claim checking in the business rules engine 173 can help reduce the likelihood that certain rules get processed or used improperly, which can occur where rules are enforced at a higher layer, such as the application layer.

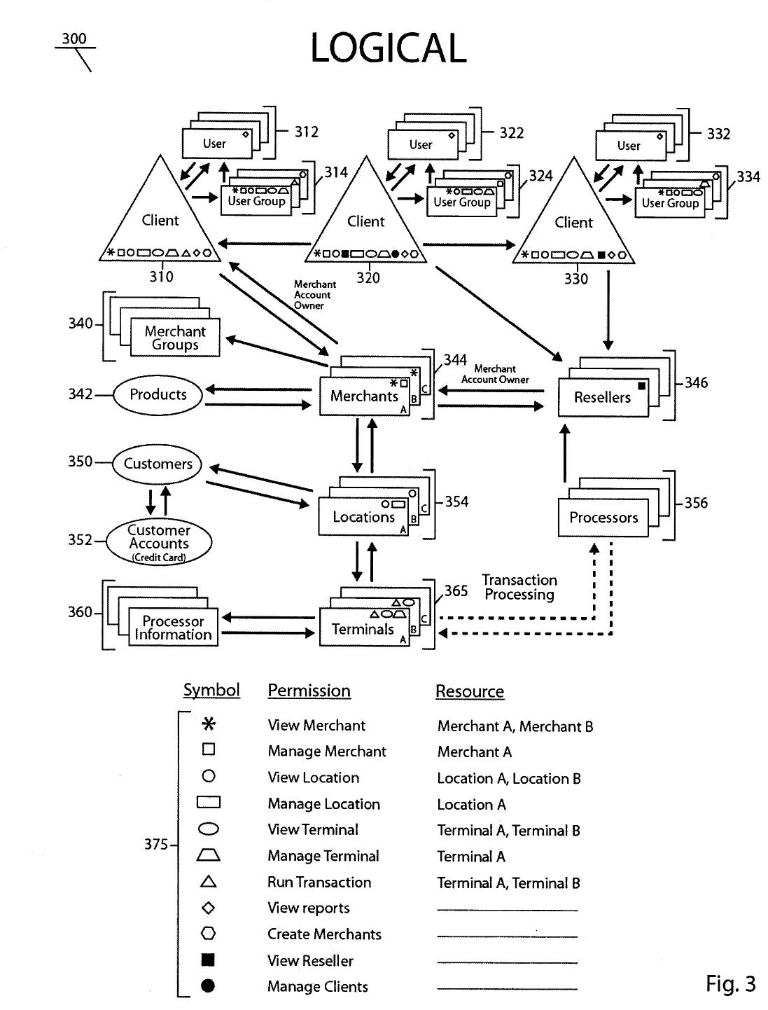

In another embodiment, the administration components engine 179 is configured to handle the administrative aspects of merchants, locations, terminals, and customers. In addition, the administration components engine 179 may be configured to manage, create, update, and/or delete all of the elements in the logical model, as illustrated in FIG. 3.

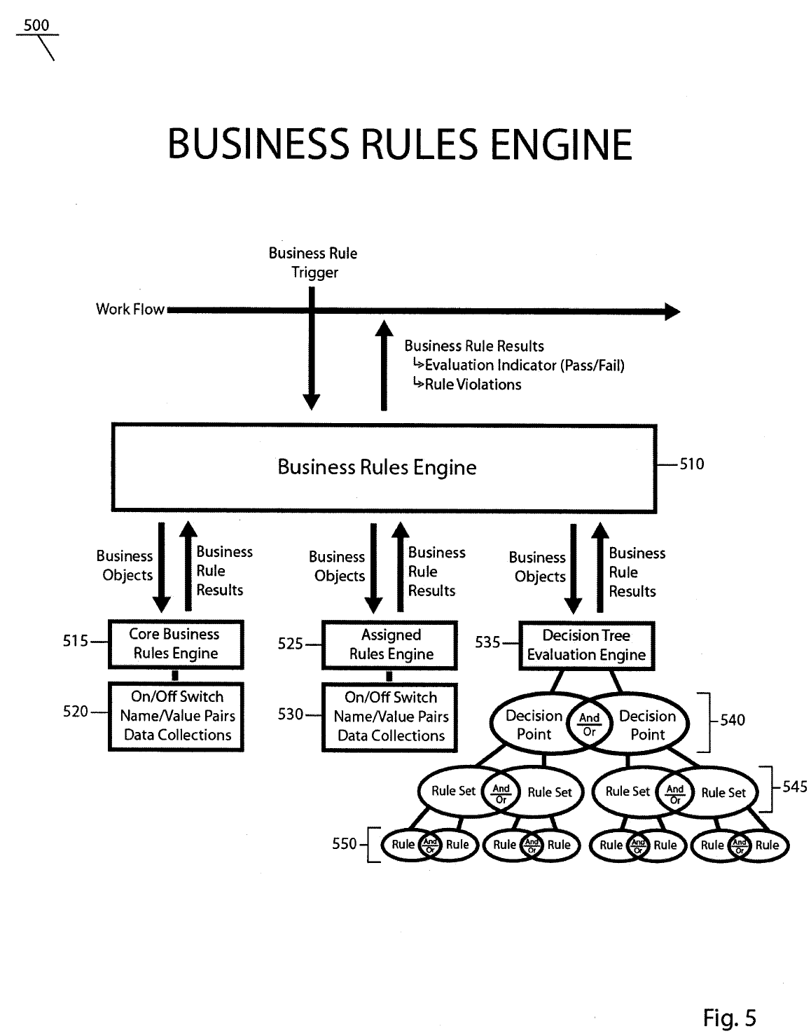

In another embodiment, encryption engine 182 is configured to provide all encryption functionality for the payment platform 105. Similarly, assigned rules engine 185 is configured to manage assigned rules, which are rules in the payment platform 105 that can be applied to any object of the system, such as client, merchant, location, terminal, and/or the user. If the user has permission to manage business rules, it may choose to opt into a specific rule. If the user chooses to opt into a rule and assign it to a client, merchant, location, terminal, or user, the user must also specify certain values and/or thresholds to which the data must conform in order to pass evaluation. In another embodiment, assigned rule values consist of a collection of data such as a whitelist of IP addresses, or the total number of times a given credit card may be run within a specified time period. The business rules engine 173, the assigned rules engine 185, and/or the decision tree evaluation engine 188 are each further described below with reference to FIG. 5.

In another embodiment, the high performance payment platform 105 is configured to be implemented on a web-based server operated by a service provider or an enterprise server operated by the owner of an enterprise capable of implementing the system 100 internally.

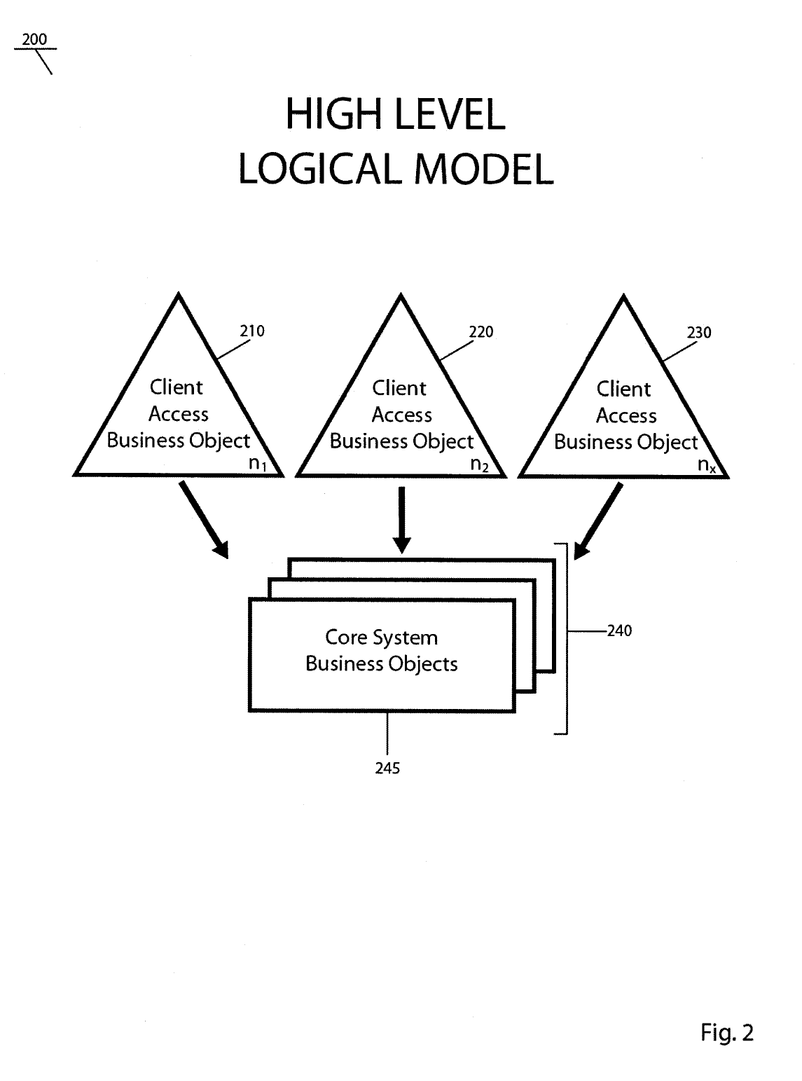

FIG. 2 illustrates an example of a logical model showing the relationships that may exist between various elements in high-performance payment platform 105. In FIG. 2, various objects may be instantiated in high-performance payment platform 105. For example, a client access business object 210, a client access business object 220, and/or a client access business object 230 may be created within the system 100. Each of the client access business objects 210, 220, 230 are configured to provide the system 100 with certain permissions to allow access to one or more system business objects 240, including, for example, core system business objects 245. In such a model, the client access business objects 210, 220, 230 are configured to provide the user of the system 100 with one or more permissions or claims to allow each such client access business object to perform a corresponding function and/or access a particular resource.

FIG. 3 illustrates a logical block diagram of a payment environment 300 that has deployed within it an embodiment of high-performance payment platform 105, which can include the navigator module 150. Client access business objects (or just clients) 310, 320, 330 can interact with one or more users 312, 322, 332 and one or more merchants 344. The scope of such interactions is determined by the permissions and claims assigned. In another embodiment, the permissions and claims are configured to be defined as illustrated in table 375 and represented graphically in the clients 310, 320 and 330. The functionality of the client 310 and client 330 may be available to any entity that has an interest in participating in a payment ecosystem. For example, the client 310 could represent a parent company or similar entity that has one or more users 312 within a subsidiary or other business unit with an interest in or need for interacting with merchants 344 and performing the corresponding transaction processing that will occur.

For each of the client 310, 320, 330, the user of the system 100 may define a set of permissions 375 to specify what functions are allowed to be carried out by one or more other users. Using the system 100, the user can provide a subset of the overall permissions that exist in the system to other clients. In another embodiment, the subset can consist of none, one, some, or all of the permissions in the system. The exact permissions provided to another client by the system owner may depend, for example, on that client's role within the system. In another embodiment illustrated in FIG. 3, the client 320 may be viewed as a system owner because it has the ability to create, update, view, and/or delete other clients, but those clients are not able to view or access the client 320 that created it or any other clients in the system.

The permission can be configured as a representation within system 300 of the ability to permit or deny a user or other client access to a particular functionality or resource. For example, permissions that could be created in an embodiment of the present inventive concept include view merchant, e.g., view the settings and permissions provided to a given merchant, manage merchant, e.g., provision, modify, or de-provision a particular merchant, view location, e.g., view the settings and permissions provided to a given location, manage location, e.g., provision, modify, or de-provision a particular location, view terminal, e.g., view the settings and permissions provided to a given terminal, manage terminal, e.g., provision, modify, and/or de-provision a particular terminal, run transaction, e.g., prepare and execute a transaction within system 300, view reports, e.g., view particular reports created within system 300, create merchants, e.g., instantiate a merchant within system 300, view reseller, e.g., view the settings and permissions provided to a given reseller, and/or manage clients, e.g., provision, modify, or de-provision a particular client. For each of the permissions, the user may provide or withhold such permission from the one or more other users. Correspondingly, the one or more other users may act or not act accordingly, thereby providing the user with a significant amount of control over the system 100.

Clients 310, 320, 330 may be a consumer of various services provided by payment environment 300. The scope of services that each of the clients 310, 320, 330 is able to employ can be defined and constrained by the permissions associated with each of the clients 310, 320, 330. The clients 310, 320, 330 may be configured with differing rights based on what is desired by the user. For example, the client 310 is configured with an ability to access merchant account information with a prescribed set of permissions set by the user. The client 320 is configured with an ability to access merchant account information as well as reseller information. The client 330 is configured to be limited with reseller access only. Yet the individuals or organizations that use the clients 310, 320, 330 may be fully independent from each other, or they could be the same, based on application of the system 100. Logical assemblages of rights and permissions can be required for various groups to accomplish authorized interactions.

In another embodiment, the user 312 may belong to one or more user groups 314, where each of such user group 314 may include a plurality of similarly situated users having identical set of permissions. Each of the user groups 314 may be defined by the user or may be pre-determined by the client 310. The user 312 may interact with the client 310 to establish permissions for the user 312 and/or for each of user groups 314. In a similar fashion, client 320 may be configured to establish permissions for one or more of the users 322 and one or more of the user groups 324, and the client 330 may be configured to establish permissions for the one or more users 332 and the one or more user groups 334. Control over the permissions provided to the user, the merchant, and/or the reseller creates a robust and secure payment environment 300. For example, the ability for the user to provide permissions to other users and other stakeholders provides a granular level of control that enhances overall security of the system 100.

In an embodiment, the client 320 may be provided with one or more permissions that allow it to be in a position superior to one or more other clients. For example, the client 320 may be provided permissions that allow it to manage the client 310 and the client 330. In FIG. 3, this is illustrated by the solid black circle permission. Such a hierarchical structure could be used in an environment where the user controls the overall operation of high-performance payment system 105. In another embodiment, such a hierarchical structure could be used where the user is operating the system 100 virtually or in a cloud-based payment system.

One or more of the merchants 344 can exist in the payment environment 300. The merchants 344 can interact with the resellers 346, the clients 310, 320, 330, and/or one or more locations 354 to conduct transactions between the entities within the payment environment 300. For purposes herein, a merchant may be any business that sells or otherwise provides goods or services 342 to customers 350, who can be provisioned with customer accounts 352, and a client is a consumer of resources or services of the system 100, e.g., users or groups of users employed by various parties including, but not limited to merchants, resellers, and/or other stakeholders.

The customer 350 may be a person who makes a purchase from a retail establishment or other sales mechanism. Customer accounts 352 can be credit cards, bank cards, and/or other payment accounts configured to make a purchase. Each location 354 can have one or more customers 350 that are shared between other locations 354 in the system that are under the same merchant 344. Customer 350 can be identified in the system 100 by information such as name, address, contact, and transaction information that may be entered by a user that has permission to create customers 350 for a given location. Customer accounts 352 such as credit cards, which can be stored in the data-tokenization software 120, can be created by a user that has permission to create credit cards. A customer credit card account includes information such as card number, expiration date, and name on card. In an embodiment, customer accounts 352 can include savings and checking accounts for ACH, Check 21, data card, and/or gift card processing.

In another embodiment, the permission controlled nature of the system 100 allows variable or hybrid business methods and processes to be employed, appropriate as desired by the user. One of the clients 310, 320, 330 may create data-tokenization software 120 tokens manually through the navigation module 150 to establish a payment record in the system 100 that can thereafter be accessed in an automated manner from the real-time processing software 135 or file-based processing software 130 interfaces. In another embodiment, the creation of data-tokenization software 120 tokens may be performed in a fully automated manner using a data-tokenization software 120 method integrated in the system 100.

Customer accounts 352 may be established by manual or automated entry of required values and/or parameters by the client 310, 320, 330 that has the permissions and/or rights to perform such a process or processes. In another embodiment, the reseller 346 using the system 100 may be provisioned with setup and review capability to access the PWS for purposes of establishing one or more accounts. In an embodiment, one or more of the merchants 344 can have various permissions provided to them. For example, merchant A can be provided the permission to view one or more merchants, e.g., as depicted by the star symbol, and manage one of those merchants (in this case it can manage itself, as depicted by the white square symbol) while merchant B could be granted only the permission to view one or more merchants.

Each one of the merchants 344 has a corresponding client designated as a merchant owner. Each one of the clients 310, 320, 330 has the ability to create one or more merchants, e.g., as depicted by the hexagon symbol of FIG. 3, and will be designated as the merchant owner for each relationship with one or more merchants 344 that it establishes. Similar to the user groups 314, 324, 334, one or more of the merchant groups 340 can be established that allow new merchants to be automatically provisioned with a pre-specified set of one or more permissions and that allow users to organize their merchants in logical groupings that make sense to them for reporting purposes. For example, a user may organize its merchants by region. In an embodiment, this could allow a user to generate reports to see how its east coast merchants are performing compared to west coast merchants. Merchant groups 340, in an embodiment, consist of a name, which identifies the group 340, and a collection of merchants. Merchants groups 340 may be set up by a user that has permission to create merchant groups 340.

In another embodiment, merchants 344 also have relationships established with resellers within payment environment 300. By way of example, a reseller can be an entity that signs up a merchant 344 for the services being provided within payment system 300, has contractual relationships with both the system owner and one or more processors, and organizes the interaction and service delivery to one or more merchants 344.

One or more of the merchants 344 may also have established one or more locations 354 from which to conduct business, including, for example, a retail store, an online store, or via a telephone call center. Each location 354 may be provided with one or more permissions including, by way of example, view location or manage location. For example, in payment environment 300, location A may be provided with the permission to view location A and location B, which is depicted by the white circle in FIG. 3, along with the permission to manage location A, which is depicted by the white rectangle in FIG. 3, while location B can be provided with the permission to only view location A and location B, which is depicted by the white circle in FIG. 3.

Each location 354 may have associated with it one or more terminals 365, e.g., a point-of-sale (POS) terminal at the front of a retail store and a back office terminal for accepting phone transactions, or an application server on the Internet. Each one of the terminals 365 may be viewed simply as an “input vector” for capturing transaction info, i.e., something that accepts transactions and generates transaction information. Each one of the terminals 365 may be provided with one or more permissions including, by way of example only, run transaction, which is depicted by the white triangle in FIG. 3, view terminal, which is depicted by the white oval in FIG. 3, and manage terminal, which is depicted by the white trapezoid in FIG. 3. For example, in payment environment 300, terminal A may be provided with the permissions to run transactions on terminals A and B, view terminals A and B, and manage terminals A and B, while location B may be provided with the permission to only run transactions on terminals A and B, and view terminals A and B.

Each of the terminals 365 is configured to utilize processor information 360, which is a set of defined parameters that instruct transactions to be routed to a specific processor 356, and can also include the format of the transaction, the form of communication protocol to be used, the time for the transaction, and other operationally-oriented business rules. In another embodiment, a processor 356 includes an endpoint within payment environment 300 that interacts in the furtherance of transaction processing. Examples of processor 356 can include, without limitation, an acquiring processor, issuing processor, ACH network operator, or some other form of financial institution.

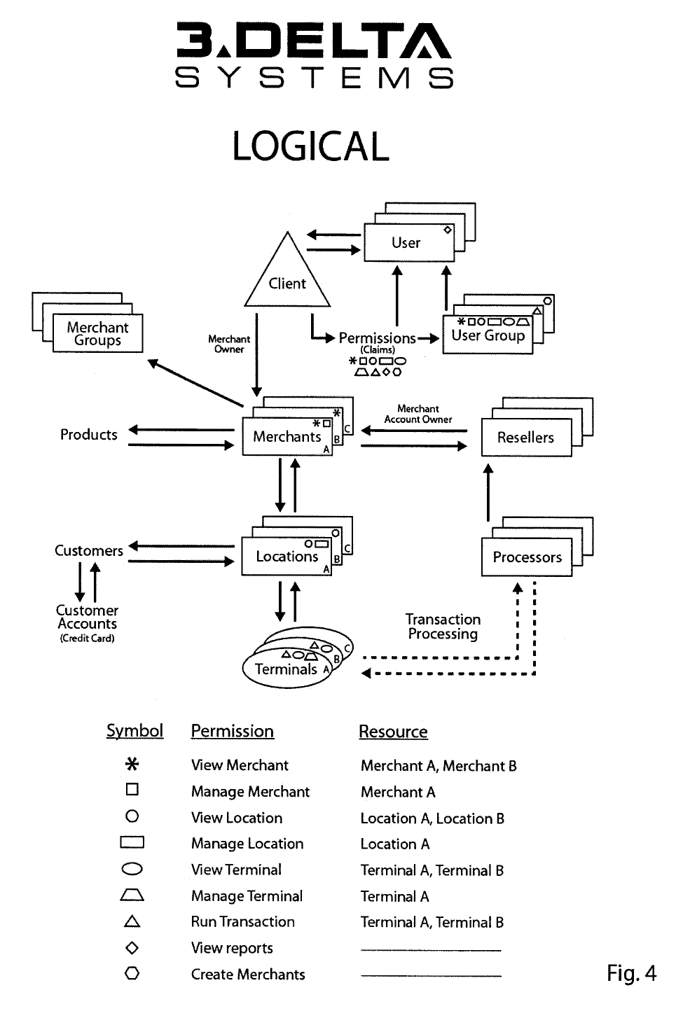

FIG. 4 illustrates another embodiment of payment environment 300, where only one client exists, which is in contrast to FIG. 3 illustrating a hierarchical arrangement of clients. Such a system could be used where only a single enterprise exists as a system owner within payment environment 300.

FIG. 5 illustrates a business rules engine 510 that may exist within the policy validation software 160. Business rules engine 510 may be application aware, and can make discrete decisions for each application, but in another embodiment and referring back to FIG. 1, the policy validation software 160 can be architecturally subordinate to the unified security layer 140. Thus, in the general case where a payment-related application 110 sends a request to the centralized processing engine, that request first passes through the unified security layer or the real-time processing software 135 which authenticates the user and ensures the user is authorized to make the request. If the user is not valid and/or does not have permission to make the request, the request is stopped. If the user is valid and has permission to make the request, such request can be submitted to core business rules engine 515 to ensure it conforms to the standard operating procedures. If the user's request fails policy validation, the request can be stopped. If the request is validated against the policy settings, the request can be sent on to the centralized processing engine and the request can be executed.

Business rules engine 510 may interact with a core business rules engine 515, an assigned rules engine 525, and a decision tree evaluation engine 535. In each case, business rules engine 515 submits the appropriate business objects and the requested action to each underlying engine, then receives back one or more business rule results corresponding to that request.

Core rules engine 515 can, in an embodiment, be used for handling core rules, which are rules in high performance payment platform 105 that can be applied to any object in the system such as client, merchant, location, terminal, or user. Once implemented, these core rules are always applied to objects in the system that are applicable to the rule based on the definition of the rule. In one embodiment, core rule values consist of a collection of data such as maximum transaction values, a blacklist of IP addresses, or verification that the amount of a refund does not exceed the amount of the original transaction.

Assigned rules engine 525 can, in another embodiment, be used for administering and applying assigned rules. Such rules may be established in high performance payment platform 105 that can be applied to any object in the system such as client, merchant, location, terminal, or user. A user with permission to manage business rules may choose to opt into a specific rule. If that user chooses to opt into a rule and assign it to a client, merchant, location, terminal, or user the user must also specify certain values or thresholds to which the data must conform in order to pass evaluation. In one embodiment, assigned rule values can consist of a collection of data such as a whitelist of IP addresses, an on/off switch, name/value pairs, data collections, or the total number of times a given credit card can be run within a specified time period.

Decision tree evaluation engine 188 can be used by business rules engine 510 for evaluating any combination of information in the system. For example, based on the business objects submitted by business rules engine 510, decision tree evaluation engine 535 might invoke one or more rules 550 that could, in an embodiment, be subordinate to one or more rule sets 545, that could in turn lead to a set of decision points 540. Based on the input and those rules, rule sets, and decision points, decision tree evaluation engine could return a business rule result to business rules engine 510.

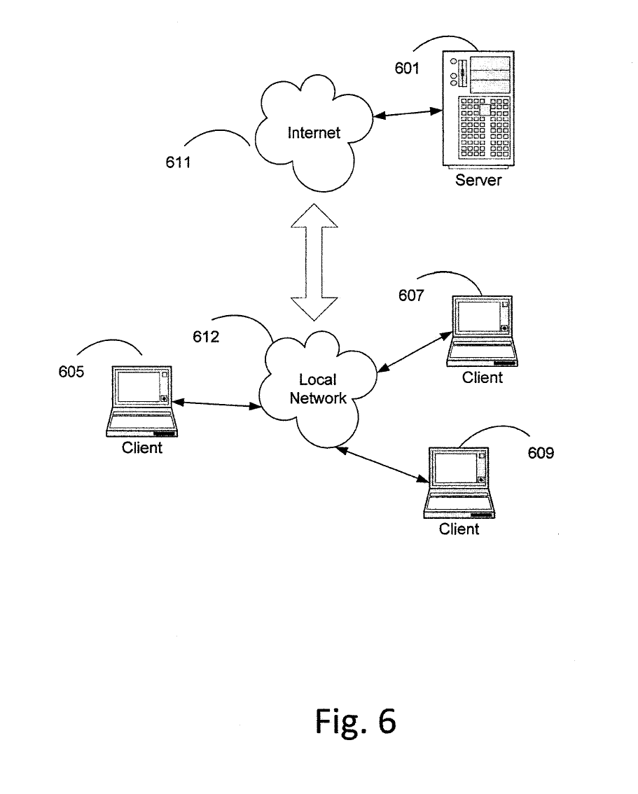

FIG. 6 is a schematic diagram of a computer network suitable for practicing the system 100. The computer network illustrated in FIG. 6 includes a plurality of computers 605, 607, 609 which are interconnected by a communication link 612. Computers 605, 607, 609 may be personal computers or computer workstations and may include a central processing unit, memory, a removable storage device, a mass storage device, a video display unit, and input/output devices such as a keyboard, mouse, or printer. For example, computers 605, 607, 609 may be conventional personal computers. Server computer 601 includes a central processing unit, memory, and a mass storage device, and may optionally include other components such as a removable storage device, a video display unit, and input/output devices. Network 612 may be, but need not necessarily be, organized in the client-server configuration illustrated in FIG. 6. In, FIG. 6, however, computer 601 operates as a server, computers 605, 607, 609 operate as clients, and computers 605, 607, 609 communicate with each other via communications link 612.

In the client-server configuration illustrated in FIG. 6, server computer 601 can include a large-capacity mass storage device that can store copies of programs and data, which are available for retrieval by the computers 605, 607, 609 over communication link 612 for use in their processing operations. Computers 605, 607, 609 may store data on the server computer 601. That data may be later retrieved by the computer that stored the data or by other computers for use in their processing operations.

Communication link 612 interconnects computers 605, 607, 609 and server computer 601 and may comprise wires, optical fibers or other media for carrying signals representing information among the computers 605, 607, 609. Each of the computers 605, 607, 609 also typically include a network interface device that connects each computer to communications link 612.

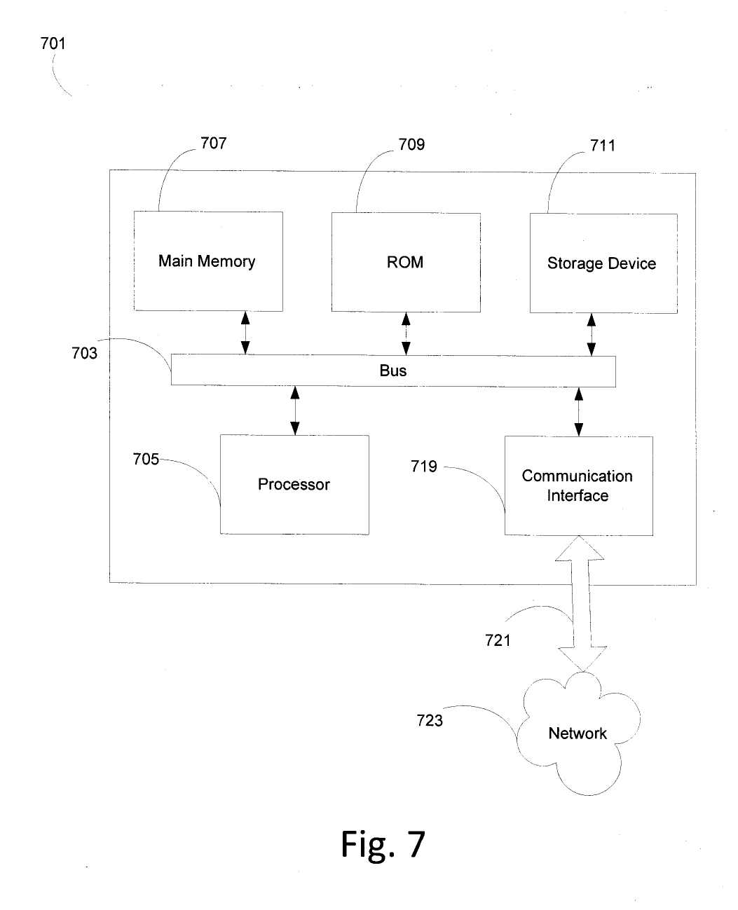

As illustrated in FIG. 7, each of computers 605, 607, 609 can be programmable machines designed to automatically carry out a sequence of arithmetic or logical operations, and may include some form of memory, at least one element that carries out arithmetic and logic operations, and a sequencing and control unit that can change the order of operations based on the information that is stored.

While variations on the present inventive concept have been described, it will be apparent to those of ordinary skill in the art that many more embodiments and implementations are possible that are within the scope of the present inventive concept. Accordingly, the present inventive concept is not to be restricted except in light of the attached claims and their equivalents.

What is claimed is:

1. A system to process a payment transaction, the system comprising:
a navigator module configured to control access to a plurality of payment-related applications, the navigator module including a plurality of permission-aware application tools including (i) a data tokenization application, (ii) online payment processing application, (iii) web-service style online interface application, and (iv) a file based interface application; and
a security application configured to define access controls, user restrictions and transaction processing thresholds of the system,
wherein,
the permission-aware application tools are made available according to permissions associated with a user,
the payment-related applications are fully interoperable, and
access to and use of each of the payment-related applications are controlled by the navigator module using granular permissions.

2. The system according to claim 1, further comprising:
a web-based server configured to store and run the system.

3. The system according to claim 1, further comprising:
an enterprise server configured to store and run the system.

4. The system according to claim 1, further comprising:
an instant help application configured to provide access to information according to the permissions associated with the user.

5. The system according to claim 1, further comprising:
a transaction processing engine configured to process the payment transaction.

6. The system according to claim 5, wherein the transaction processing engine is configured to automatically identify and use an associated processor to void the payment transaction.

7. The system according to claim 5, wherein,
the payment transaction is a rejected payment transaction, and
the transaction processing engine is configured to (i) recognize the rejected payment transaction, (ii) identify and communicate with a processor to request verbal authorization, and (iii) process the rejected payment transaction upon verbal authorization.

8. A method to classify business flows to determine what flows should continue and what flows should be handled as exceptions due to a business rule violation, the method comprising:
receiving one or more business rule triggers;
receiving one or more business objects;
exchanging information with at least one of a core business rules engine, an assigned rules engine, and a decision tree evaluation engine;
performing a first checking step of predefined business rules in a core business rules engine;
performing a second checking step of business rules in an assigned rules engine;
performing a decision process by combining results from the first checking step and the second checking step; and
outputting a business rule result.

9. A method to create, assign, and manage permissions and claims, the method comprising:
controlling access at least one payment-related application via a navigator module including at least one permission-aware application tool; and
defining access controls, user restrictions, and transaction processing thresholds of the system via a security application,
wherein,
the at least one permission-aware tool is made available according to at least one permission associated with at least one user, and
access to the at least one payment-related application is controlled by the navigator module using granular permissions.

10. The method of claim 9, wherein the at least one permission-aware application tool includes (i) a data tokenization application, (ii) online payment processing application, (iii) web-service style online interface application, and (iv) a file based interface application.

11. The method of claim 9, wherein at least one payment-related application includes a plurality of payment-related application that are fully interoperable with each other.

12. The method of claim 9, further comprising:
storing and running the system via a web-based server.

13. The method of claim 9, further comprising:
storing and running the system via an enterprise server.

14. The method of claim 9, further comprising:
providing access to information according to the permissions associated with the user via an instant help application.

15. The method of claim 9, further comprising:
processing the payment transaction via a transaction processing engine.

16. The method of claim 15, further comprising:
automatically identifying and using an associated processor to void the payment transaction via the transaction processing engine.

17. The method of claim 15, further comprising,
using the transaction processing engine to (i) recognize the payment transaction, (ii) identify and communicate with a processor to request verbal authorization, and (iii) process the payment transaction upon verbal authorization.
